(19) United States
(12) Patent Application Publication
(10) Pub. No.: US 2012/0271558 A1
(43) Pub. Date: Oct. 25, 2012

(54) SYSTEM AND METHOD FOR IDENTIFYING AND CLASSIFYING RESISTANCE GENES OF PLANT USING HIDDEN MARCOV MODEL

(75) Inventors: Cheol Goo Hur, Daejeon (KR); Jung Eun Kim, Daejeon (KR); Bong Woo Lee, Daejeon (KR); Seung Won Lee, Daejeon (KR); Ji Man Hong, Daejeon (KR)

(73) Assignee: Korea Research Institute of Bioscience and Biotecn, Daejeon (KR)

(21) Appl. No.: 13/515,006

(22) PCT Filed: Jan. 19, 2010
(86) PCT No.: PCT/KR10/00333

§ 371 Date: Jun. 11, 2012

(30) Foreign Application Priority Data
Dec. 11, 2009 (KR) 10-2009-0123006

(51) Int. Cl. G06F 19/24

(52) U.S. Cl. 702/19

(57) ABSTRACT

The present invention relates to a system and a method for quickly and accurately identifying and classifying resistance genes of a plant from a protein or DNA sequence. In order to identify and classify resistance genes of a plant using a hidden marcov model, conceived is a profile matrix made using a protein sequence of a domain which is encoded by the resistance genes, and a system for identifying the domain of the resistance genes using the profile matrix and classifying the resistance genes by domain combination. The present invention enables effective identification and classification of the resistance genes of a plant using the profile matrix and program, of which the nucleotide base sequence or protein sequence is detected.

### TECHNICAL FIELD

The present invention relates to a method of identifying and classifying a domain of a resistance gene based on a scoring matrix which is constructed to search for a domain encoding a plant resistance gene using a Hidden Markov Model, and a recording medium on which a computer readable program for executing the method is recorded.

### BACKGROUND ART

Plant receives various attacks from pathogenic bacteria, such as bacteria, fungi, and eelworms under external environments. To resist attacks from such external environments, plant has its own immune system to induce a defense mechanism. The defense mechanism operates by initiation of a signal delivery by a resistance gene that recognizes a foreign molecule. The resistance gene detects an effector protein, which is delivered into a plant cell from a pathogen, or a pathogen associated molecular pattern (PAMP), such as lipopolysaccride, peptidoglycan, or glycoprotein, and initiate a signal for driving an immune system, thereby inducing a hypersensitive response (Gohre, V. and S. Robatzek, 2008, Breaking the Barriers: Microbial Effector Molecules Subvert Plant Immunity. Annu Rev Phytopathol).

Plant resistance genes consist of several conserved functional domain sets, and can be roughly classified into five groups according to a combination of such functional domains (Dangl, J. L. and J. D. Jones, 2001, Plant pathogens and integrated defenceresponses to infection. Nature. 411(6839): p. 826-33). The largest group is a nucleotide binding site (NBS)-leucine rich repeat (LRR) domain group that encodes NBS and LRR. This group is sub-classified into a toll interleukine-1 like receptor (TIR)-NBS-LRR (TNL) group and a coiled-coil (CC)-NBS-LRR (CNL) group, according to whether TIR domain, or CC or leucine-zipper (LZ) domain exists at an amino terminus thereof. Also, a resistance gene existing in a cell membrane encodes LRR domain on an extracellular region and encodes transmembrane (TM) domain, which is a cell membrane permeation domain. Resistance genes belonging to this group can be classified as a leucine rich repeat- receptor kianse (LRR-RK) group and a leucine rich repeat receptor protein (LRR-RP), according to whether a kinase domain is encoded in a cytoplasm. The last group is a set of resistance genes that encode a kinase domain in a cytoplasm and do not include a TM domain.

Sequence production technologies have been developed so that non-processed sequences of commercially useful plant sources are being supplied in a large-scale. However, a method of quickly and accurately identifying and classifying a plant resistance gene has not been systemically constructed. Conventionally, as a method of identifying a resistance gene, an identification method using similarity search based on, for example, a Blast program with respect to a large-scale database using a computer technology, and an experimental identification method using a primer that is prepared using a well-known conserved sequence have been generally used.

In the case of similarity search, even a protein that has relatively low similarity or a protein that has high local similarity is classified as the same group as a reference resistance gene. Accordingly, the similarity search method has low accuracy.

In the case of the method of identifying a resistance gene using a primer that is prepared using a well-known conserved sequence, when a primer is prepared based on a sequence of a conserved domain of a species that has is not closely-associated with a test plant, the primer may not act properly, thereby making the gene identification difficult. Also, many variables need to be taken into consideration, thereby leading to high experimental costs and long time.

To prevent these problems, the present invention provides a method of identifying a domain that encodes a resistance gene based on a profile matrix, which is constructed using a conserved protein sequence of a domain that encodes a resistance gene and a Hidden Markov Model, and a method of classifying as a resistance gene according to a combination of the identified domains.

### DETAILED DESCRIPTION OF THE INVENTION

### Technical Problem

The present invention provides a system and method for effectively identifying a plant resistance gene which is known or unknown in previous studies, from many nucleotide sequences or protein sequences.

According to the present invention, to effectively identify a domain that encodes a resistance gene, a profile matrix of domains of a resistance gene was constructed based on a Hidden Markov Model, and a program for searching for a resistance gene domain was developed based on the profile matrix. Also, a plant resistance gene was classified as five groups according to a combination of domains of a resistance gene, and even a gene that encodes only some domains of the resistance gene was classified according to a combination of domains. Therefore, according to the present invention, a resistance gene can be classified as a total of 12 sub-groups

### Technical Solution

According to an aspect of the present invention, there is provided a system and method including an algorithm for identifying a domain of a resistance gene using a profile matrix that is constructed using a protein sequence corresponding to a functional domain of a resistance gene and a Hidden Markov Model, and for classifying a resistance gene according to a combination of resistance gene domains.

According to another aspect of the present invention, there is provided a recording medium on which a computer readable program for executing the method is recorded.

### Advantageous Effects

An unknown resistance gene candidate set is quickly and efficiently identified from many plant sequences. An unknown resistance gene candidate set is identified from many sequences downloaded from disclosed database. A resistance gene that encodes the whole domain and a gene that encodes only some domains are all screened, so that a candidate set of a resistance gene may be easily screened from many sequences.

### BRIEF DESCRIPTION OF THE DRAWINGS

FIG. 1 is a schematic view of a system for identifying and classifying a plant resistance gene.

FIG. 2 shows a pseudo-code of search elements which are used to parse a resistance gene in a UniPort flatfile.

FIG. 3 shows phylogenetic assay results obtained using sequences of an NBS domain that has a TIR domain at its amino terminus and an NBS domain that does not have a TIR domain at its amino terminus. A tree corresponding to a red rod on a right-hand side indicates genes encoding an NBS domain that has a TIR domain, and a tree corresponding to a blue rod indicates genes encoding an NBS domain that does not have a TIR domain.

FIG. 4 shows a diagram depicted using NBS domain alignment results of a TNL group and a CNL group to allow comparison of names of active motives and sequence alignment results.

FIG. 5 is a graph of scores of search results of protein sequences belonging to CNL, TNL, NL groups, using two NBS domain profile matrices. Blue and pink lines respectively indicate expect values obtained by performing hmmpfam using NBS_CC and NBS_TIR profile matrices. A Y axis represents an expect value, and an X axis is a resistance gene classification group of an input sequence.

FIG. 6 shows a flowchart illustrating a method of constructing a profile matrix of a domain that encodes a resistance gene.

FIG. 7 shows a schematic diagram illustrating a resistance gene classification process according to a combination of resistance gene domains. A diamond shape indicates the name of a domain. A red diamond indicates a domain which is identified using a profile matrix, a green diamond indicates a coiled-coil domain which is identified using COILS program, and a violet color indicates a TM domain which is identified using TMHMM. A red line indicates five major resistance gene groups, and a blue line indicates a gene group which has the same structure as a known gene that binds to or is associated with a resistance gene so as to be engaged in plant immune signal transduction. A black line indicates a resistance gene group which is highly likely to have been a resistance gene or to evolve into a resistance gene in the future, although its function has not been revealed.

FIG. 8 illustrates an input unit for receiving an input of a sequence to identify and classify a resistance gene.

FIG. 9 shows the entire screen of Genomic Data and UniGene output unit: 1) Genomic Data, and 2) UniGene.

FIGS. 10 and 11 illustrate captured seven detail items, displayed by the output unit: 1) HMM results, 2) sequence information, 3) gene structure and homologous protein group, 4) blast results, 5) related reference, 6) tree and 7) sequence alignment.

FIG. 12 illustrates a portion of detailed information of an output unit of a resistance gene predicted using UniGene data: 1) sequence information, and 2) information about tissue specificity.

FIG. 13 shows search results: 1) a distribution of a resistance gene of Medicago truncatula species in Genomic Data according to a classification group and ID of a protein belonging to CNL classification group, 2) as UniGene results, a distribution of a resistance gene of 32 species of plant, and as detailed items, resistance gene classification and distribution of Arabidopsis plant.

FIG. 14 shows an example of identifying a domain of a resistance gene using a profile matrix.

### BEST MODE FOR CARRYING OUT THE INVENTION

A system for identifying resistance gene-associated domains by processing a great amount of plant protein or nucleotide sequence, and classifying a resistance gene based on a combination of the domains,

according to an embodiment of the present invention, includes:

an input unit for inputting a protein sequence or a nucleotide sequence for identifying and classifying a resistance gene;

a process unit for identifying domains encoding a resistance gene from the input sequence using a profile matrix, followed by classification of the resistance gene;

a database for storing a resistance gene which is identified and classified according to an algorithm of the process unit;

an output unit for displaying detailed information of a resistance gene from results stored in the database using data;

an input unit for inputting a protein sequence or a nucleotide sequence for searching for a domain that encodes a resistance gene;

a process unit for identifying a domain using a Hidden Markov Model of a resistance gene;

an output unit for displaying an identified domain;

a search unit for screening using a database that is constructed by identifying and classifying a resistance gene from protein or UniGene sequences stored in existing public database; and

an output unit for displaying the gene structure, homologous gene search results, tree with respect to homologous gene, and sequence alignment results of a resistance gene identified from screened genes.

The profile matrix of the system according to an embodiment of the present invention may be constructed as follows:

a) downloading a whole plant sequence from public database to search for a sequence corresponding to a functional domain of a resistance gene;

b) determining a resistance gene candidate set corresponding to a training set for constructing a profile matrix by performing domain name search, description entry search, and keyword search based on the downloaded sequence;

c) collecting only experimentally valuable sequences as a protein sequence of a resistance gene by removing a gene that comprises only a fragment sequence, and a gene that has an expected sequence from the candidate set;

d) identifying a resistance gene-encoding domain through pfam and multiple Em for motif elicitation (MEME) program based on the protein sequence;

e) parsing a protein sequence corresponding to a domain region from the respective program results, followed by sequence alignment using clustalW program; and

f) comparing sequence alignment results of domains with previously known domain characteristics to manual-verify that conserved sequences are properly aligned, and constructing a profile matrix of the verified domain using HMMER program.

In a system according to an embodiment of the present invention, the public database in operation a) may be UniProt, but is not limited thereto.

In a system according to an embodiment of the present invention, the resistance gene-encoding domain in operation d) may be nucleotide binding site (NBS), leucine zipper (LZ), leucine rich repeat (LRR), toll interleuine-1 receptor (TIR), or kinase, but is not limited thereto.

In a system according to an embodiment of the present invention, the algorithm may be an algorithm in which a domain is identified using proper boundary values of matrices and resistance genes are classified based on a combination of the identified domain.

A method of identifying domains associated with plant resistance gene and classifying an identified resistance gene,

according to an embodiment of the present invention, includes:

a) inputting a protein sequence or a nucleotide sequence as a query on an input window;

b) when the input sequence is a nucleotide sequence, translating using 6 reading frames and defining the longest ORF from translation results;

c) identifying a domain of a resistance gene from the input protein sequence or translated protein sequence using a profile matrix;

d) classifying as a resistance gene group using a combination of the identified domains;

e) comparing the classified resistance gene with a gene that is known as a resistance gene on commercially available database using a BLAST algorithm; and

f) analyzing phylogenetic tree using multiple sequence alignment with respect to a resistance gene group having similarity and neighbor joining (NJ) algorithm.

The profile matrix in operation c) according to an embodiment of the present invention may be constructed as follows:

downloading a whole plant sequence from public database to search for a sequence corresponding to a functional domain of a resistance gene;

determining a resistance gene candidate set corresponding to a training set for constructing a profile matrix by performing domain name search, description entry search, and keyword search based on the downloaded sequence;

collecting only experimentally valuable sequences as a protein sequence of a resistance gene by removing a gene that comprises only a fragment sequence, and a gene that has an expected sequence from the candidate set;

identifying a resistance gene-encoding domain through pfam and multiple Em for motif elicitation (MEME) program based on the protein sequence;

parsing a protein sequence corresponding to a domain region from the respective program results, followed by sequence alignment using clustalW program; and

comparing sequence alignment results of domains with previously known domain characteristics to manual-verify that conserved sequences are properly aligned, and constructing a profile matrix of the verified domain using HMMER program.

In a method according to an embodiment of the present invention, the public database may be UniProt, but is not limited thereto.

In a method according to an embodiment of the present invention, the resistance gene-encoding domain may be nucleotide binding site (NBS), leucine zipper (LZ), leucine rich repeat (LRR), toll interleuine-1 receptor (TIR), or kinase, but is not limited thereto.

The present invention also provides a recording medium on which a computer readable program for executing the method is recorded.

Hereinafter, embodiments of the present invention are described in detail below.

In a system according to an embodiment of the present invention, the algorithm of the process unit may construct a profile matrix using the following method to identify domain from input protein sequences or nucleotide sequences.

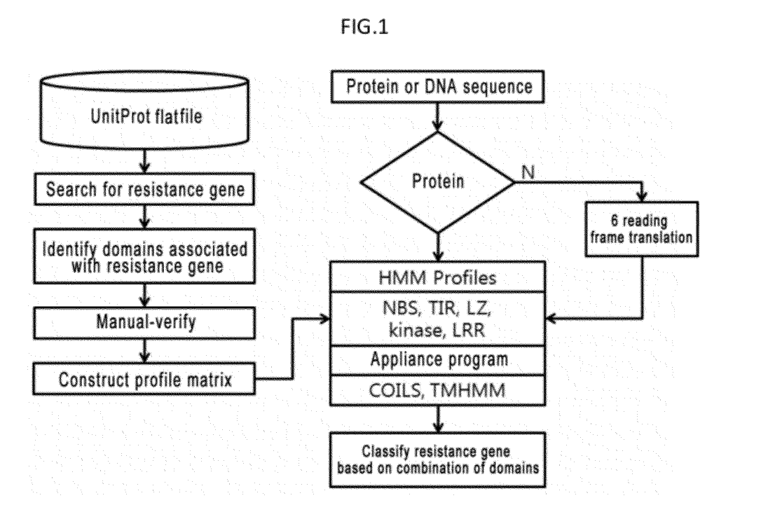

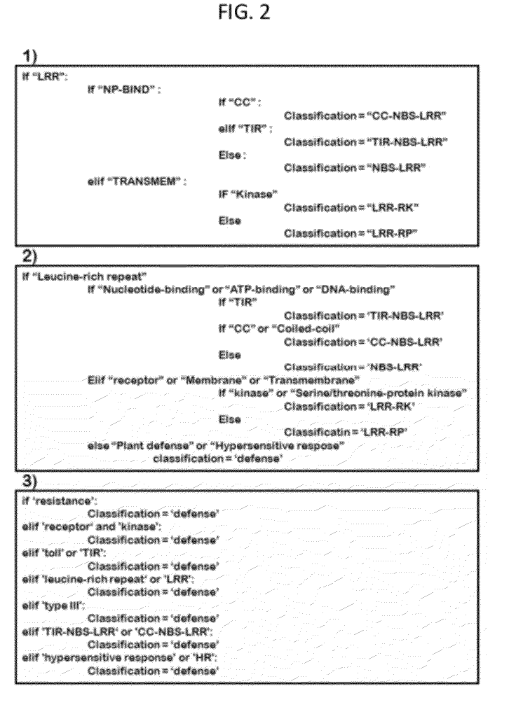

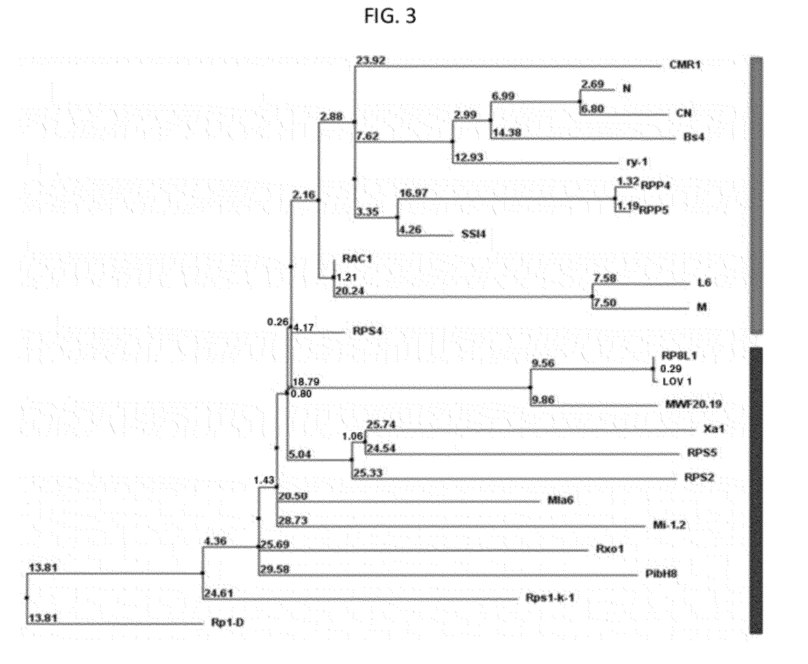

To search for a sequence corresponding to a functional domain of a resistance gene, a whole plant sequence was downloaded from UniProt, which is a public database. Domain name search (FIG. 2-1), description entry search (FIG. 2-2), and keyword search (FIG. 2-3) were performed on UniProt flatfile to determine a resistance gene candidate set corresponding to a training set for constructing a profile matrix. From the resistance gene candidate set, a gene that includes only a fragment sequence, and a gene that has an expected sequence were removed, and and only experimentally valuable sequences were collected as a protein sequence of a resistance. Based on the sequence, five resistance gene-encoding domains, that is, nucleotide binding site (NBS), leucine zipper (LZ), leucine rich repeat (LRR), toll interleuine-1 receptor (TIR), and kinase were identified using pfam and MEME program. From the respective program results, protein sequences corresponding to these domains were parsed, and sequence alignment was performed thereon using clustalW (ver. 2.0.9) program. Sequence alignment results of the respective domains were compared with previously known domain characteristics to manual-verify that conserved sequences were properly aligned, and profile matrices of the verified domains were constructed using HMMER (ver. 2.3.2) program.

In an example of constructing a profile matrix of a resistance gene-associated domain, characteristics of domains were identifiable. In the example, a method of embodying a profile matrix of a NBS domain was presented, and profile matrices of other four domains were also constructed in a similar manner. An NBS domain shows a distinctive difference between when a TIR domain exists in a terminal region of an amino acid and when CC or LZ exists in a terminal region of an amino acid.

To verify that the same phenomenon occurs in the sequence used in embodiments of the present invention, a group having an NBS protein sequence belonging to a TNL group is referred to as NBS_TIR, and a group having an NBS protein sequence belonging to a CNL group is referred to as NBS_CC. These groups were mixed and phylogenetic assay was performed thereon. As a result, it was confirmed that an NBS domain of the TNL group and an NBS domain of the CNL group are classified as completely different groups on the phylogenetic tree (FIG. 3).

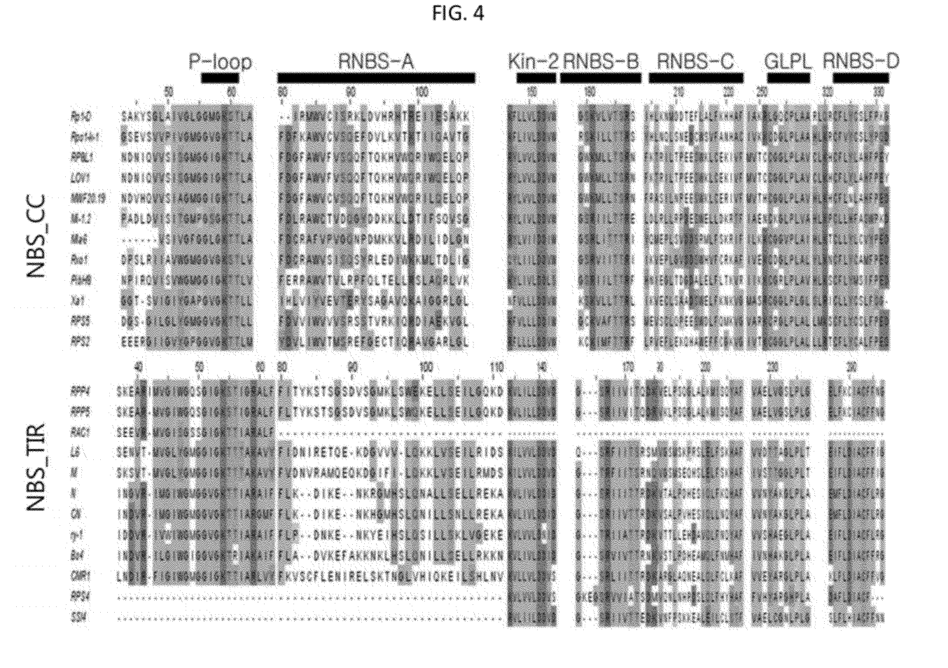

To confirm the difference on a protein sequence, sequence alignment results were compared by manual. As a result, it was confirmed that there is a difference in a conserved sequence in a region that is marked as an active motif in existing papers (FIG. 4).

Existing studies reported that an NBS motif has 7 active domains: P-loop, RNBS-A, kinase-2 (Kin-2), RNBS-B, RNBS-C, GLPL, and RNBS-D. Sequence alignment results were arranged based on conserved active motif, and conservation degrees were compared (FIG. 4). As a result, it was confirmed that the P-loop domain was conserved in a wider range of the sequence of the NBS_TIR group than in the sequence of the NBS_CC group. In regard to the final amino acid of kinase2 (Kin-2) motif, in the NBS_TIR group, an aspartic acid (D) is conserved, and in the NBS_CC group, tryptophan is conserved. RNBS-A, RNBS-C, and RNBS-D motifs are very different between the two groups in terms of a sequence and a length, and in the case of RNBS-C and RNBS-D domains, the NBS_CC group showed a higher conservation degree. Due to such differences, it can be assumed that the NBS domains of the NBS_TIR group and the NBS_CC group form independent groups on a phylogenetic assay. Also, when profile matrices of the two groups are embodied, an expect rate of an NBS domain may be increased, and also, the two domains may be able to be distinguished from each other.

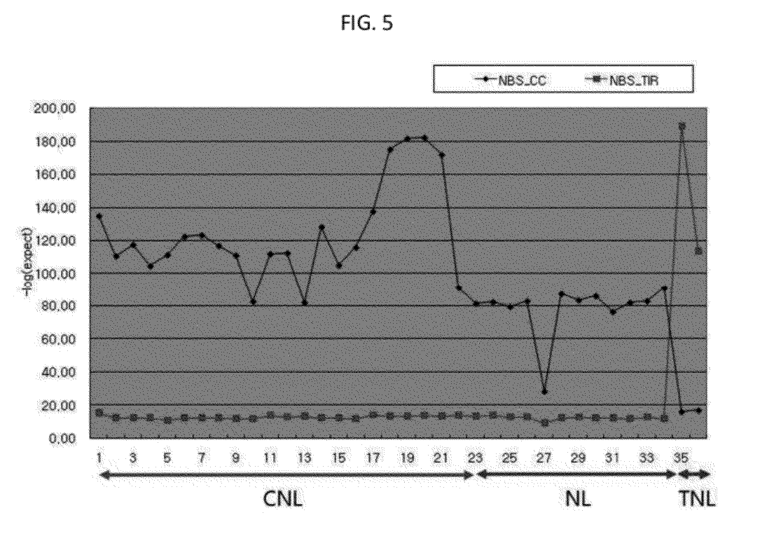

Based on the fact above, NBS_TIR and NBS_CC profile matrices were independently constructed, and to confirm that the two NBS profile matrices each distinguish a corresponding group from protein sequences actually belonging to different groups, a sequence that encodes CNL and TNL and some sequences that encode an NBS-LRR (NL) group having an unknown amino group were received from UniProta, and the identification process was performed using hmmpfam program and the NBS domain profile matrices, and expect values were compared (FIG. 5).

An expect value obtained by executing hmmpfam using an NBS domain profile matrix made from a sequence having a coiled-coil as the amino group of the NBS domain was represented as blue, and an expect value obtained by executing hmmpfam using an NBS domain profile matrix made from a sequence having TNL as the amino group of the NBS domain was represented as pink. As a result, it was confirmed that the CNL protein sequence has a higher value in the NBS_CC profile matrix, and the TNL protein sequence has a higher value in the NBS_TIR profile matrix, and when a fragment sequence of NBS is input, the two domains showed a distinguished value difference. Accordingly, it was determined that the two matrices enable NBS domains to be classified (FIG. 5).

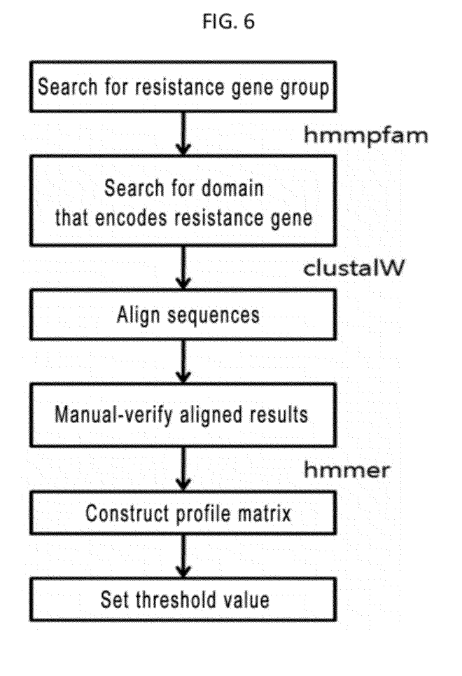

Domains that encode a resistance gene were constructed in the same manner as used in constructing the NBS domain profile matrix (FIG. 6). A profile matrix was constructed by sequence alignment, manual-verification of aligned sequence, profile matrix construction using a Hidden Markov Model, and setting of a threshold value in consideration of lengths and similarity of the respective domains through repeatedly performed experiments.

In a system according to an embodiment of the present invention, a profile matrix about the resistance gene-encoding domain and a threshold value that is used in identifying domains using the profile matrix may be an algorithm for identifying a domain that encodes a significant resistance gene from a protein sequence which is processed by an input unit.

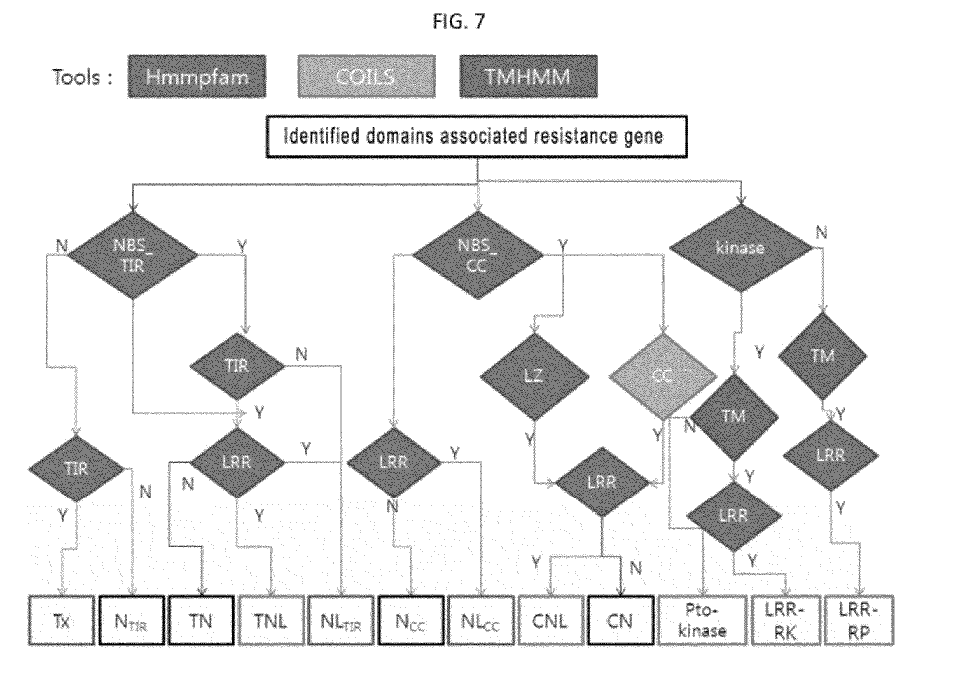

A process of identifying and classifying a resistance gene using a profile matrix may be expected based on a protein sequence. Accordingly, to enable this analysis, when the analysis is performed based on a nucleotide sequence, translation is executed using 6 reading frames, and a reading frame that encondes the longest protein sequence is selected to proceed the resistance gene analysis. A resistance gene-associated domain is identified using hmmpfam program and a profile matrix constructed using the method described above, and in consideration of thresholds of the respective domains which are set through repeatedly performed experiments to classify a resistance gene, finallly, it is determined whether the domain is a resistance gene-encoding domain. A combination of resistance gene domains which are identified using this method are used to determine a class of the resistance gene (FIG. 7).

In a system according to an embodiment of the present invention, the algorithm for identifying the resistance gene-encoding domain may be an algorithm in which a protein sequence is translated from a nucleotide sequence processed by the input unit, and then, a profile matrix and a threshold of a corresponding domain are used to identify a domain that encodes a significant resistance gene.

In an algorithm for classifying a resistance gene of a system according to an embodiment of the present invention, an NBS domain is determined as an NBS_TIR group or an NBS_CC group according to which value is higher from among expect values obtained by performing hmmpfam using NBS_TIR and NBS_CC matrices. If the identified gene has a LRR domain of a carboxyl group having an expect value equal to or higher than a threshold value and TIR is identified in the amino group, a corresponding gene is classified as a TNL group, and if a coiled-coil (CC) domain or a leucine zipper (LZ) domain is identified, a corresponding gene is classified as a CNL group.

In the case in which NBS domain is identified but LRR of the carboxyl group is not identified, if TIR is identified in the amino group, a corresponding gene may be classified as a TN group, and if the coiled-coil domain or the LZ domain is identified, a corresponding gene may be classified as a CN group. When only the LRR domain is included in the same gene as the identified NBS domain, a corresponding gene may be classified as NL_{TIR} and NL_{CC}, and when other domains that encode a resistance gene are not included, a corresponding gene may be classified as N_{TIR} and N_{CC}. Regarding the respective gene in the four groups, whether an amino group belongs to TIR, or CC, or LZ is determined according to an expect value obtained using the NBS profile matrix.

In the process above, the coiled-coil domain is predicted using COILS (version 2.2) program. Also, to identify a resistance gene receptor which exists in a cell membrane, the construction of a transmembrane (TM), which is expected to be located in a cell membrane, is identified using TMHMM (version 2.0c) program. When the TM construction is identified, according to whether a kinase domain that has an expect value equal to or greater than a threshold value exists in a carboxyl group, a gene is classified as LRR-RK and LRR-RP group. When a kinase domain that does not have the TM construction and has an expect value equal to or greater than a threshold value exists, a gene is classified as pto-kinase.

The combination of a resistance gene described above is a resistance gene that belongs to five representative categories in plant. In the system according to the present embodiment, in addition to the five categories, a combination having a similar structure is also used to classify a resistance gene, due to the disclosure that a protein that is not considered as a resistance gene but has a similar structure thereto induces immune reaction by binding with or relating to a resistance gene. Accordingly, a resistance gene was classified as a total of 12 groups (TNL, pto-like kinase, LRR-RP, LRR-RK, NLcc, Tx, NLtir, CNL, Ntir, TN, CN, Ncc). For example, if a TIR domain has an expect value equal to or greater than a threshold value while NBS or LRR is not identified, the TIR domain may be classified as Tx.

Data corresponding to a search unit according to the present invention was made by downloading sequence and library information from UniGene database of NCBI, which is public database, and processing the downloaded information. When the UniGene data is output, together with an output unit of a protein, tissue specificity using Audic's test was verified using a library distribution of expressed sequence tag (EST) included in UniGene. Audic's test may be an algorithm for calculating tissue specificity using Equation 1.

$$p ( y \vert x ) = {( \frac{N 2}{N 1} )}^{y} \frac{( x + y ) !}{x ! y ! {( 1 + \frac{N 2}{N 1} )}^{( x + y + 1 )}} \qquad ( Equation 1 )$$

(wherein y and x respectively represent numbers of libraries of EST belonging to a particular gene in a particular tissue and in all the tissues other than the particular tissue, and N2 and NI are values indicating that how all EST are distributed in a particular tissue, and respectively represent numbers of EST included in a particular tissue and tissues other than the particular tissue.)

The present invention also provides a recording medium on which a computer readable program for executing a method of identifying and classifying a plant resistance gene is recorded. In detail, the present invention provides a recording medium on which a computer readable program for executing a method of identifying a domain of a plant resistance gene using a protein sequence or a nucleotide sequence, and classifying the plant resistance gene is recorded.

A computer readable recording medium refers to any recording medium that is directly read by a computer and allows access of a computer. The recording medium may be a magnetic recording medium, such as a floppy disk, a hard disk, or a magnetic tape, an optical recording medium, such as CD-ROM, CD-R, CD, RW, DVD-ROM, DVD-RAM, or DVD-RW, an electric recording medium, such as RAM or ROM, or a mixture thereof (for example: magnetic/optical recording medium, such as MO), but is not limited thereto.

A device for recording or inputting on the recording medium or a device or apparatus'for reading information on the recording medium may vary according to the kind of a recording medium and an access method. Also, various data processor program, software, comparator, and format are used to record a program for executing a method according to the present invention. Corresponding information may be represented in a form of a binary file formatted using commercially available software, a text file, or an ASCII file.

With reference to the attached drawings, embodiments of the present invention are described in detail below.

FIG. 1 is a schematic view of a system for identifying a domain of a plant resistance gene and classifying a resistance gene.

A system according to an embodiment of the present invention includes the input unit, the process unit, the database, the output unit, and the search unit, which are all described above.

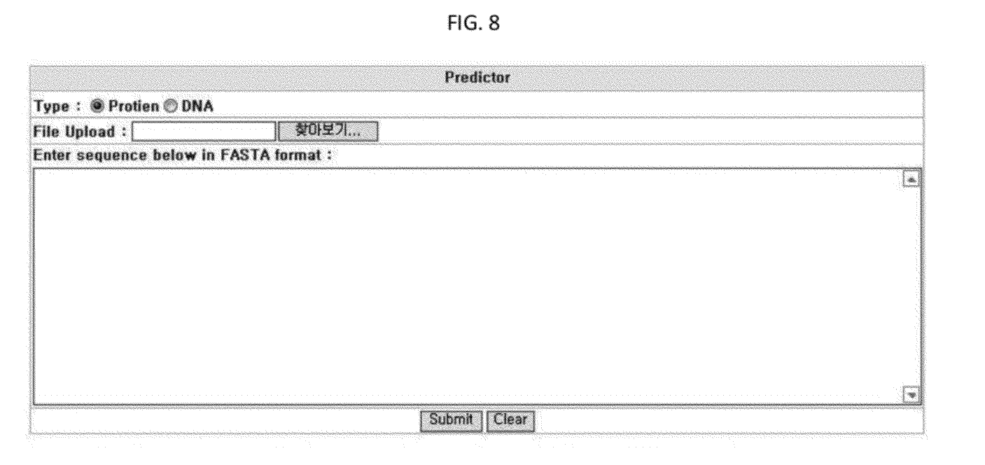

The input unit performs a function of inputting a protein sequence or a nucleotide sequence. FIG. 8 shows an input unit screen. A protein, a nucleotide base type, and a protein or nucleotide sequence in a fasta format, which are necessary input elements, are input.

The process unit identifies a resistance gene domain from the input sequence information using a profile matrix, and classifies a resistance gene and stores the resistance gene in database.

The database stores data obtained during the process unit performs an analysis process using an algorithm for identifying a resistance gene encoding domain and classifying a resistance gene. Domain database stores predicted results of a resistance gene-encoding domain, and resistance gene-classification database stores classification information obtained using a resistance gene classification algorithm, and protein and nucleotide sequences. UniProt BLAST and RefSeq BLAST database store results about similarity degrees between a gene classified as a resistance gene and a gene group with similarity to a resistance gene protein derived from public database UniProt and NCBI.

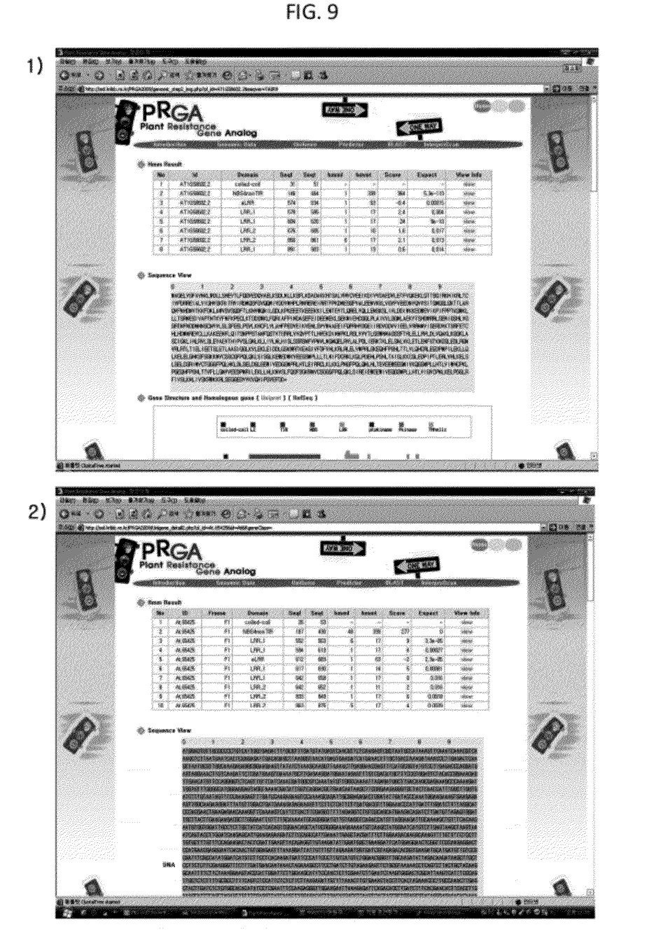

The output unit outputs information that is processed by the process unit and then stored in the database on the Web. FIG. 9 shows results- processed by the process unit on a system. The output unit displays a predicted result (FIG. 9-1) obtained using a protein sequence and a predicted result (FIG. 9-2) obtained using a nucleotide sequence of UniGene in a different manner. The output unit of the protein sequence consists of HMM results, sequence information, a gene structure or homologous protein group, a blast result, a related reference, a tree, and sequence alignment results.

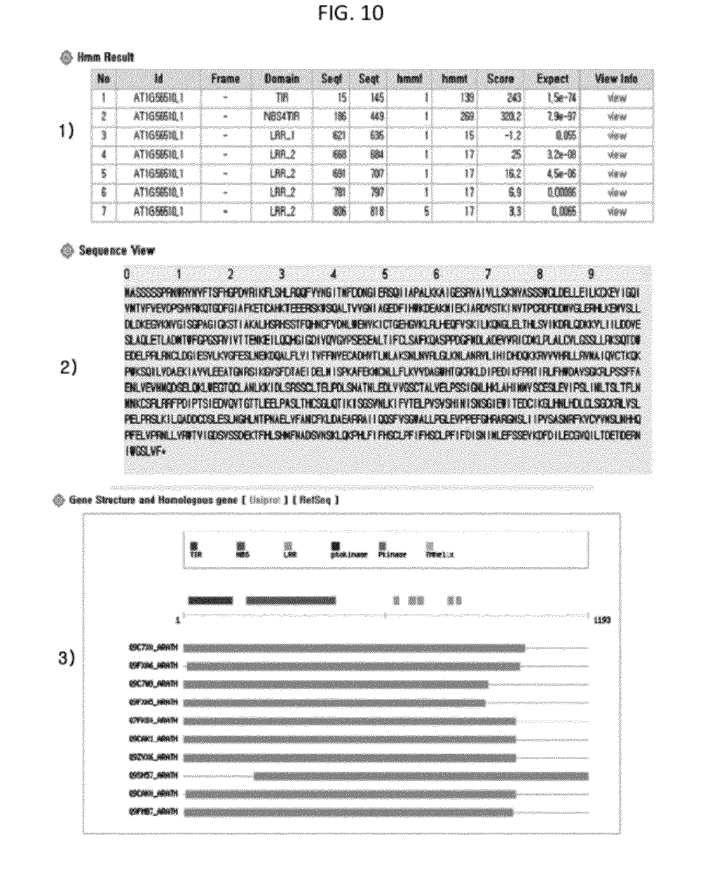

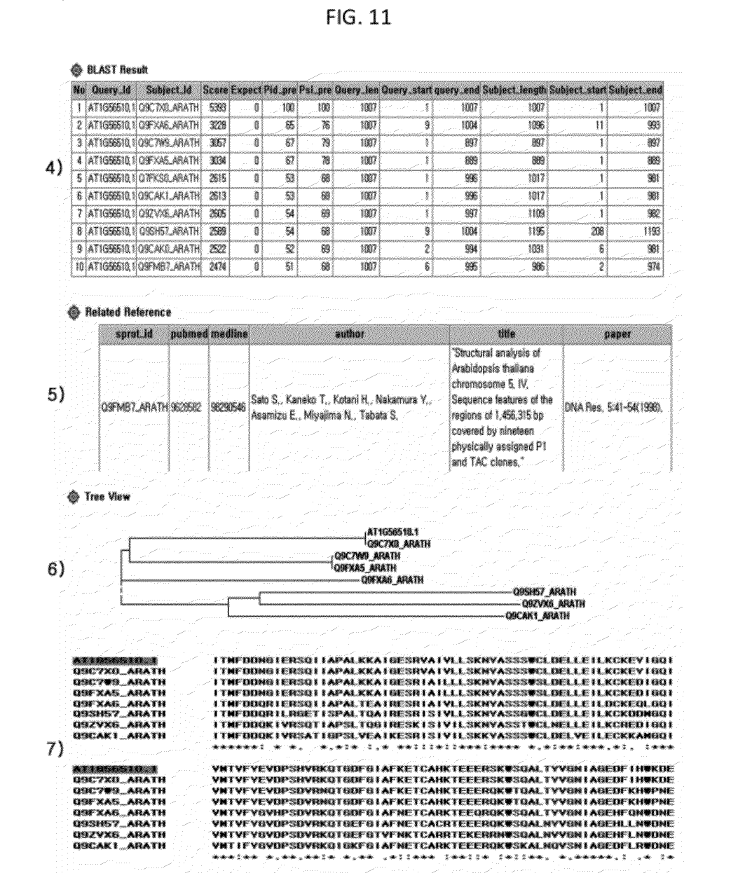

FIGS. 10 and 11 show an example of detailed list results of a resistance gene constructed using a protein sequence. HMM Result shows results obtained by identifying a resistance gene domain using hmmpfam and a profile matrix constructed by the algorithm. The table of HMM Result shows domains of resistance gene, and locations thereof on a protein sequence and on a matrix, and the item of View Info shows actual pfam results. The sequence information item shows an amino acid sequence of a protein classified as a resistance gene. Gene Structure and Homologous gene shows the structure of a resistance gene domain depicted using the domain identification results, and shows a relative location of a protein with simifarity to a protein stored in public database UniProt or NCBI after similarity search is performed using Blast algorithm. Blast result shows locations where similarity exists and similarity degrees of a protein with similarity to a resistance gene, which are depicted as a table. Related Reference contains information about journals disclosing experimental results of a protein with similarity to a resistance gene on database, and journals are linked to a PubMed Web, allowing high access to associated information.

Tree View shows an associated relationship between sequences with similarity to a query sequence, and is constructed using Neighbor-Joining(NJ) algorithm. Sequence alignment results are results obtained by performing multiple sequence alignment(MSA) using clustalW to distinguish a homologous region between sequences with similarity to a query sequence that is input in the input unit.

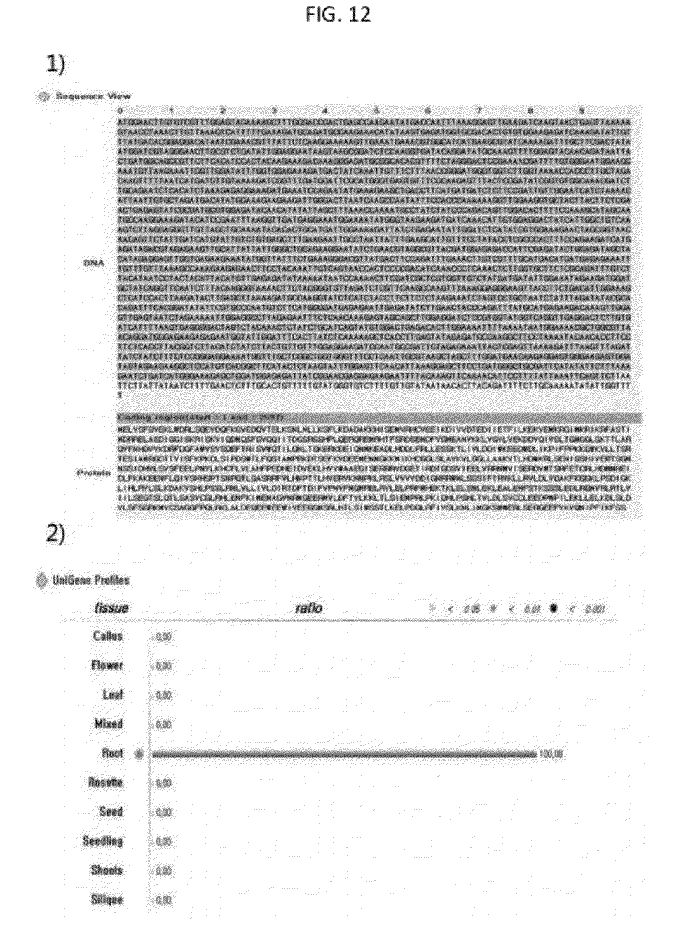

FIG. 12 shows an output unit about results obtained by predicting and classifying a resistance gene using a nucleotide based sequence, which summarizes a portion that is not dealt by the output unit about prediction results obtained using a protein. UniGene translates using 6 reading frames based on a nucleotide sequence and predicts based on a protein sequence having the longest open reading frame (ORF). Accordingly, the sequence information shows together the input nucleotide sequence and a protein sequence corresponding to the longest ORF (FIG. 12-1). Also, if there is information about a library of UniGene, results obtained by statistically calculating tissue specificity using tissue information on the library are also shown (FIG. 12-2). Detailed information other than these two pieces of information are identical to those of the output unit of a resistance gene predicted based on a protein sequence.

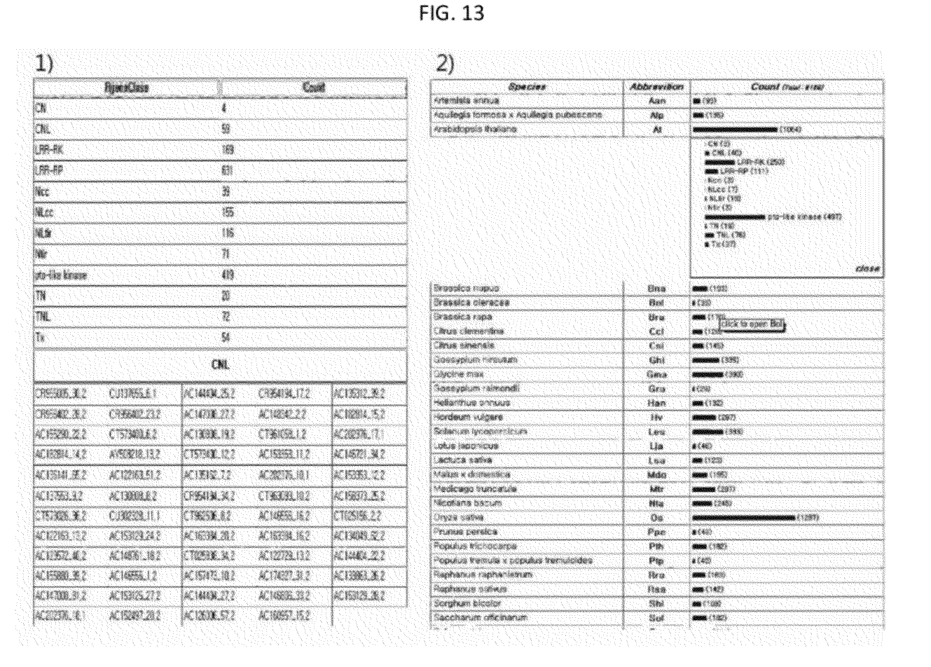

FIG. 13 shows a system corresponding to the search unit, and the algorithm embodied in the present system and sequence information supplied by public database are used to classify as a resistance gene group, following by storage on database, and classified results are subjected to search on the constructed database. Regarding a search method, in the case of Genomic Data, five known species of plants (Arabidopsis, Rice, Medicaro, Corn, and Grape) that have completely determined genome sequences and disclosed predicted protein sequences were analyzed. When a species name displayed on a lower portion of Genomic Data is clicked on, the number of resistance genes according to the respective classifications is displayed on an upper portion of Genomic Data and gene ids of a particular classification group are displayed on the lower portion (FIG. 13-1). To obtain detail information about a resistance gene, the id of a gene is clicked on to have an access to database and to display detailed information. When the gene id is clicked on, gene information of a protein corresponding to the id can be output and displayed in the same manner as the output unit. In the case of UniGene, when clicked on, information about 32 species of resistance genes supplied by NCBI is displayed, and when a graph illustrating a species name or the number of resistance genes of a corresponding gene is clicked on, a classification group of a particular species and the number of resistance genes of a corresponding classification group are displayed (FIG. 13-2).

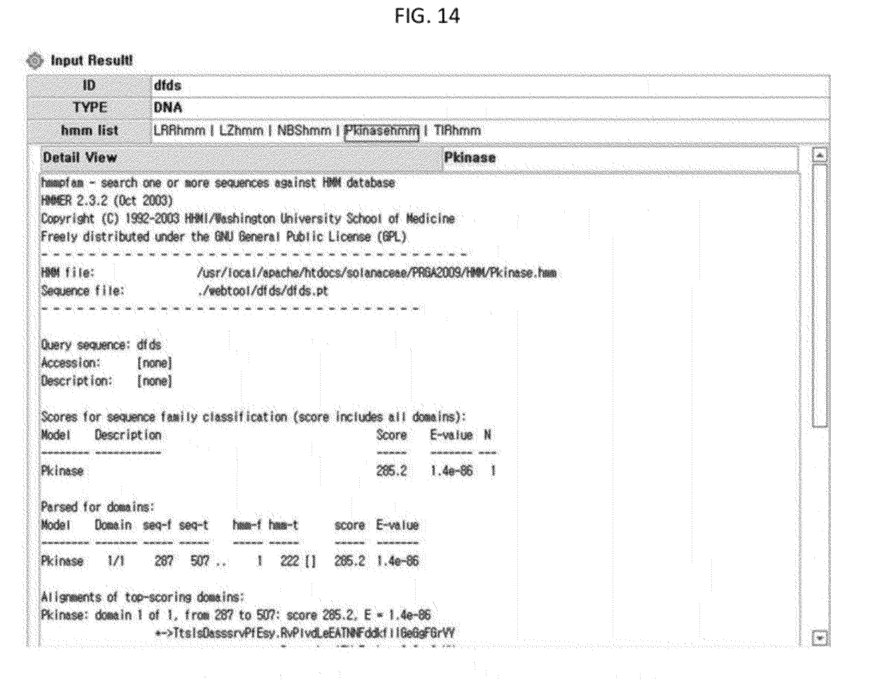

The input unit for identifying a resistance gene using a profile matrix described with reference to the algorithm is the same as the input unit of FIG. 8. A profile matrix is constructed based on five domains (LRR, LZ, NBS, Pkinase, and TIR), and when a domain name is clicked on and a sequence is input, in the case of a protein, a chosen profile matrix is searched for and output, and in the case of a nucleotide sequence, a profile matrix is searched for and output after processed with a protein sequence of the longest ORF from among results obtained by translating using 6 reading frames. FIG. 14 shows profile matrix search results of a Pkinase domain.

As described above, one of ordinary skill in the art may understand that the present invention may be embodied in other detailed forms without any change in the technical concept or necessary features thereof. Accordingly, the above-described embodiments are exemplary only on all of the aspects, and are not restricted. The scope of the present invention is defined by the following claims, rather than the detailed description section, and any change or changed forms, originated from the meaning, range, and equivalent concept of the claims, must be interpreted as being included in the scope of the present invention.

1. A system for identifying resistance gene-associated domains by processing a great amount of plant protein or nucleotide sequence, and classifying a resistance gene based on a combination of the domains, the system comprising:
an input unit for inputting a protein sequence or a nucleotide sequence for identifying and classifying a resistance gene;
a process unit for identifying domains encoding a resistance gene from the input sequence using a profile matrix, followed by classification of the resistance gene;
a database for storing a resistance gene which is identified and classified according to an algorithm of the process unit;
an output unit for displaying detailed information of a resistance gene from results stored in the database using data;
an input unit for inputting a protein sequence or a nucleotide sequence for searching for a domain that encodes a resistance gene;
a process unit for identifying a domain using a Hidden Markov Model of a resistance gene;
an output unit for displaying an identified domain;
a search unit for screening using a database that is constructed by identifying and classifying a resistance gene from protein or UniGene sequences stored in existing public database; and
an output unit for displaying the gene structure, homologous gene search results, tree with respect to homologous gene, and sequence alignment results of a resistance gene identified from screened genes.

2. The system of claim 1, wherein the profile matrix is constructed by the following operations:
a) downloading a whole plant sequence from public database to search for a sequence corresponding to a functional domain of a resistance gene;
b) determining a resistance gene candidate set corresponding to a training set for constructing a profile matrix by performing domain name search, description entry search, and keyword search based on the downloaded sequence;
c) collecting only experimentally valuable sequences as a protein sequence of a resistance gene by removing a gene that comprises only a fragment sequence, and a gene that has an expected sequence from the candidate set;
d) identifying a resistance gene-encoding domain through pfam and multiple Em for motif elicitation (MEME) program based on the protein sequence;
e) parsing a protein sequence corresponding to a domain region from the respective program results, followed by sequence alignment using clustalW program; and
f) comparing sequence alignment results of domains with previously known domain characteristics to manual-verify that conserved sequences are properly aligned, and constructing a profile matrix of the verified domain using HMMER program.

3. The system of claim 2, wherein the public database in operation a) is UniProt.

4. The system of claim 2, wherein the resistance gene-encoding domain in operation d) is nucleotide binding site (NBS), leucine zipper(LZ), leucine rich repeat (LRR), toll interleuine-1 receptor (TIR), or kinase.

5. The system of claim 1, wherein the algorithm is an algorithm in which domains are identified using proper boundary values of matrices and a resistance gene is classified based on a combination of the identified domains.

6. A method of identifying domains associated with plant resistance gene and classifying an identified resistance gene, the method comprising:
a) inputting a protein sequence or a nucleotide sequence as a query on an input window;
b) when the input sequence is a nucleotide sequence, translating using 6 reading frames and defining the longest ORF from translation results;
c) identifying a domain of a resistance gene from the input protein sequence or translated protein sequence using a profile matrix;
d) classifying as a resistance gene group using a combination of the identified domains;
e) comparing the classified resistance gene with a gene that is known as a resistance gene on commercially available database using a BLAST algorithm; and
f) analyzing phylogenetic tree using multiple sequence alignment with respect to a resistance gene group having similarity and neighbor joining(NJ) algorithm.

7. The method of claim 6, wherein the profile matrix in operation c) is embodied using the following operations:
downloading a whole plant sequence from public database to search for a sequence corresponding to a functional domain of a resistance gene;
determining a resistance gene candidate set corresponding to a training set for constructing a profile matrix by performing domain name search, description entry search, and keyword search based on the downloaded sequence;
collecting only experimentally valuable sequences as a protein sequence of a resistance gene by removing a gene that comprises only a fragment sequence, and a gene that has an expected sequence from the candidate set;
identifying a resistance gene-encoding domain through pfam and multiple Em for motif elicitation (MEME) program based on the protein sequence;
parsing a protein sequence corresponding to a domain region from the respective program results, followed by sequence alignment using clustalW program; and
comparing sequence alignment results of domains with previously known domain characteristics to manual-verify that conserved sequences are properly aligned, and constructing a profile matrix of the verified domain using HMMER program.

8. The method of claim 7, wherein the public database is UniProt.

9. The method of claim 7, wherein the resistance gene-encoding domain in operation d) is nucleotide binding site (NBS), leucine zipper(LZ), leucine rich repeat (LRR), toll interleuine-1 receptor (TIR), or kinase.

10. A recording medium on which a computer readable program for executing the method of claim 6 is recorded.
